(19) United States
(12) Patent Application Publication
(10) Pub. No.: US 2025/0365624 A1
(43) Pub. Date: Nov. 27, 2025

(54) DEVICE AND METHOD FOR PERFORMING HANDOVER IN WIRELESS COMMUNICATION SYSTEM

(71) Applicant: Samsung Electronics Co., Ltd., Suwon-si (KR)

(72) Inventors: Taiho YOON, Suwon-si (KR); Donghoo LEE, Suwon-si (KR)

(21) Appl. No.: 19/287,350

(22) Filed: Jul. 31, 2025

Related U.S. Application Data
(63) Continuation of application No. PCT/KR2023/020358, filed on Dec. 12, 2023.

(30) Foreign Application Priority Data
Feb. 3, 2023 (KR) 10-2023-0015146
Feb. 7, 2023 (KR) 10-2023-0016430

(51) Int. Cl. H04W 36/00; H04W 74/0833

(52) U.S. Cl. CPC H04W 36/0072; H04W 74/0833

(57) ABSTRACT

The present disclosure relates to a 5^{th} generation (5G) or pre-5G communication system supporting higher transmission rates than 4^{th} generation (4G) communication systems such as long-term evolution (LTE). Provided is a method performed by a distributed unit (DU) of a target base station in a wireless communication system, comprising: receiving data, to be forwarded to a user equipment, from a central unit (CU) of another base station, wherein the data includes data that the user equipment could not receive from a source base station due to a handover; receiving a random access preamble from the user equipment; transmitting a response to the random access preamble to the user equipment; receiving a handover complete message from the user equipment; and in response to receiving the handover complete message, transmitting, to the user equipment, the data received from the CU of the target base station before receiving the random access preamble.

### CROSS-REFERENCE TO RELATED APPLICATIONS

This application is a continuation of International Application No. PCT/KR2023/020358 designating the United States, filed on Dec. 12, 2023, in the Korean Intellectual Property Receiving Office and claiming priority to Korean Patent Application Nos. 10-2023-0015146, filed on Feb. 3, 2023, and 10-2023-0016430, filed on Feb. 7, 2023, in the Korean Intellectual Property Office, the disclosures of each of which are incorporated by reference herein in their entireties.

### BACKGROUND

### Field

The disclosure relates to a mobile communication system and, for example, to a device and method for performing handover in the mobile communication system.

### Description of Related Art

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a “beyond 4G network” communication system or a “post long term evolution (post LTE)” system.

The 5G communication system is considered to be implemented in ultrahigh frequency (mmWave) bands, (e.g., 60 GHz bands) so as to accomplish higher data rates. To decrease propagation loss of the radio waves and increase the transmission distance of radio waves in the ultrahigh frequency bands, beamforming, massive multiple-input multiple-output (massive MIMO), full dimensional MIMO (FD-MIMO), array antenna, analog beam forming, large scale antenna techniques are under discuss ion in the 5G communication systems.

In addition, in the 5G communication system, technical development for system network improvement is under way based on evolved small cells, advanced small cells, cloud radio access networks (cloud RANs), ultra-dense networks, device-to-device (D2D) communication, wireless backhaul, moving network, cooperative communication, coordinated multi-points (COMPs), reception-end interference cancellation, and the like.

In the 5G system, hybrid FSK and QAM modulation (FQAM) and sliding window superposition coding (SWSC) as an advanced coding modulation (ACM) scheme, and filter bank multi carrier (FBMC), non-orthogonal multiple access (NOMA), and sparse code multiple access (SCMA) as an advanced access technology have also been developed.

There is a need to improve a handover procedure in a mobile communication system.

### SUMMARY

According to various example embodiments of the disclosure, a method performed by a distributed unit (DU) of a target base station in a mobile communication system may include: receiving, from a central unit (CU) of the target base station, data to be forwarded to a user equipment (UE), wherein the data includes data that the UE does not receive from a source base station due to a handover, receiving a random access preamble from the UE, transmitting a response to the random access preamble to the UE, receiving a handover complete message from the UE, and in response to the reception of the handover complete message, transmitting, to the UE, the data received from the CU of the target base station before receiving the random access preamble.

According to various example embodiments of the disclosure, a method performed by a central unit (CU) of a target base station in a mobile communication system may include: receiving, from a source base station, configuration information related to a handover of a user equipment (UE), receiving, from the source base station, data to be forwarded to the UE, based on the configuration information related to the handover, wherein the data includes data that the UE does not receive from the source base station due to handover, and transmitting the received data to a distributed unit (DU) of the target base station before the DU of the target base station receives a random access preamble from the UE.

According to various example embodiments of the disclosure, a distributed unit (DU) of a target base station in a mobile communication system may include: a controller, comprising circuitry, and a transceiver connected to the controller, wherein the controller may be configured to cause the DU to: receive, from a central unit (CU) of the target base station, data to be forwarded to a user equipment (UE), wherein the data includes data that the UE does not receive from a source base station due to a handover, receive a random access preamble from the UE, transmit a response to the random access preamble to the UE, receive a handover complete message from the UE, and in response to the reception of the handover complete message, transmit, to the UE, the data received from the CU of the target base station before receiving the random access preamble.

According to various example embodiments of the disclosure, a central unit (CU) of a target base station in a mobile communication system may include: a controller, comprising circuitry, and a transceiver connected to the controller, wherein the controller may be configured to cause the CU to: receive, from a source base station, configuration information related to a handover of a user equipment (UE), receive, from the source base station, data to be forwarded to the UE, based on the configuration information related to the handover, wherein the data includes data that the UE does not receive from the source base station due to handover, and transmit the received data to a distributed unit (DU) of the target base station before the DU of the target base station receives a random access preamble from the UE.

According to various example embodiments of the disclosure, it is possible to efficiently improve the handover procedure in a mobile communication system.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example mobile communication system according to various embodiments;

FIG. 2 is a diagram illustrating an example of a handover procedure according to various embodiments;

FIG. 3 is a diagram illustrating an example protocol stack of a target base station in a mobile communication system according to various embodiments;

FIG. 4 is a diagram illustrating an example core network and a base station in a mobile communication system according to various embodiments;

FIG. 5 is a signal flow diagram illustrating an example of a handover procedure in a mobile communication system according to various embodiments;

FIG. 6 is a flowchart illustrating an example of a handover procedure of a central unit (CU) of a target base station in a mobile communication system according to various embodiments;

FIG. 7 is a flowchart illustrating an example of a handover procedure of a distributed unit (DU) of a target base station in a mobile communication system according to various embodiments;

FIG. 8 is a block diagram illustrating an example configuration of a base station in a wireless communication system according to various embodiments;

FIG. 9 is a block diagram illustrating an example configuration of a distributed unit (DU) of a target base station in a wireless communication system according to various embodiments; and

FIG. 10 is a block diagram illustrating an example configuration of a UE in a wireless communication system according to various embodiments.

### DETAILED DESCRIPTION

The terms used in the disclosure are used merely to describe various example embodiments, and are not intended to limit the scope of the disclosure. A singular expression may include a plural expression unless they are clearly different in \context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various example embodiments of the disclosure will be described based on an approach of hardware. However, various embodiments of the disclosure include a technology that uses both hardware and software, and thus the various embodiments of the disclosure may not exclude the perspective of software.

Furthermore, various example embodiments of the disclosure may be described using terms used in some communication standards (e.g., the 3rd generation partnership project (3GPP)), but they are for illustrative purposes only. Various embodiments of the disclosure may also be easily applied to other communication systems through modifications.

In the following description, terms referring to signals (e.g., message, signal, signaling, sequence, and stream), terms referring to resources (e.g., symbol, slot, subframe, radio frame (RF), subcarrier, resource element (RE), resource block (RB), bandwidth part (BWP), and occasion), terms for operations (e.g., step, method, process, and procedure), terms referring to data (e.g., information, parameter, variable, value, bit, symbol, and codeword), terms referring to channels, terms referring to control information (e.g., downlink control information (DCI), medium access control codeword element (MAC CE), and radio access control (RRC) signaling), terms referring to network entities, terms referring to device elements, and the like are illustratively used for the sake of convenience. Therefore, the disclosure is not limited by the terms as described below, and other terms referring to subjects having equivalent technical meanings may be used.

Various aspects are described herein in connection with a wireless terminal and/or a base station. A wireless terminal may refer to a device providing voice and/or data connectivity to a user. The wireless terminal may be connected to aa computing device such a laptop computer or desktop computer. The wireless terminal may also be called a system, a subscriber unit, a subscriber station, a mobile station, a mobile, a remote station, a remoter terminal, an access terminal, a user terminal, a terminal, a wireless communication device, a user agent, a user device, or a user equipment. The wireless terminal may be a subscriber station, a wireless device, a cellular phone, a portable device having radio access capability, or any other processing device connected to a wireless modem. A base station (e.g., access point) may refer to a device in an access network that communicates with wireless terminals over the air interface through one or more sectors. The base station also coordinates management of attributes for the air interface.

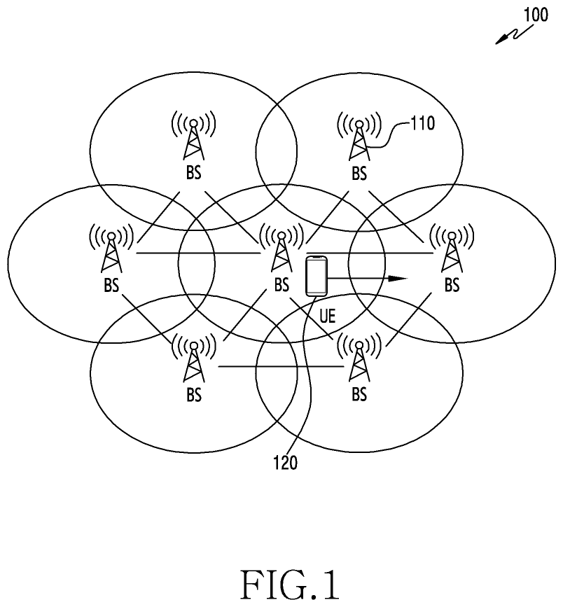

FIG. 1 is a diagram illustrating an example mobile communication system according to various embodiments. A base station 110 and a UE 120 are described as parts of nodes using a radio channel in a mobile communication system 100.

The base station 110 is a network infrastructure providing radio access to the UE 120. The base station 110 has coverage defined as a predetermined geographic area based on a distance at which a signal may be transmitted. In addition to the base station, the base station 110 may be referred to as an “access point (AP), an “eNodeB (eNB)”, a “5th generation node (5G node)”, a “next generation node B (gNB)”, a “5G nodeB (5gNB)”, a “wireless point”, a “transmission/reception point (TRP)”, a “digital unit (DU)”, a “radio unit (RU)”, a “remote radio head (RRH)”, or another term having a technical meaning equivalent thereto.

The base station 110 according to various embodiments of the disclosure may be implemented to form an access network having a distributed deployment as well as an integrated deployment. According to an embodiment, the base station 110 may be divided into a central unit (CU) and a distributed unit (DU), and the CU may be implemented to perform upper layers (e.g., packet data convergence protocol (PDCP), RRC) and the DU may be implemented to perform lower layers (e.g., medium access control (MAC), physical (PHY)). The DU of the base station 110 may form beam coverage on a radio channel.

The UE 120 may refer to a device used by a user and performs communication with the base station 110 through a radio channel. In some cases, the UE 120 may be operated without user involvement. For example, the UE 120 is a device that performs machine type communication (MTC), and may not be carried by the user. In addition to terminal, the UE 120 may be referred to as a “user equipment (UE)”, a “mobile station”, a “subscriber station”, a “remote terminal”, a “wireless terminal”, an “electronic device”, a “user device”, or another term having a technical meaning equivalent thereto. The UE 120 according to various embodiments of the disclosure may include, for example, at least one of a cellular phone, a smartphone, a computer, a tablet PC, a mobile phone, a video phone, an e-book reader, a desktop PC, a laptop PC, a netbook computer, a workstation, a server, a medical device, a camera, a wearable device, a multimedia system capable of performing a communication function, or the like. The type of the UE 120 is not limited to the above examples.

Referring to FIG. 1, as the user equipment (UE) 120 moves, the base station 110 accessed by the UE 120 may be changed. The UE 120 may perform handover. The base stations 110 may be connected to some of the surrounding base stations 110. The base station 110 may be a mobile communication base station irrelevant to radio access technology such as LTE, NR, or Wi-Fi. The UE 120 may be connected to the base station 110 to receive a mobile communication service, and as the UE 120 moves, in order to change the base station 110, the UE 120 and the base station 110 may continue to receive mobile communication services without interruption through a handover (HO) procedure. The serving base station before moving may be referred to as a source base station (or serving cell, source cell), and the newly connected base station after moving may be referred to as a target base station (or target cell).

A cell may refer to an area that may be covered by a single base station. The single base station may cover one cell or may cover multiple cells. The multiple cells may be classified by the frequency they support and the area of the sector they cover. In the disclosure, the base station 110 may be used as a term including a cell, or the cell may be used as a term referring to the base station 110. Hereinafter, the disclosure is described as a source base station/target base station to explain handover according to movement of the UE 120, but it will be apparent that expressions having the same technical meaning, such as source cell/target cell or serving cell/target cell, may be used instead.

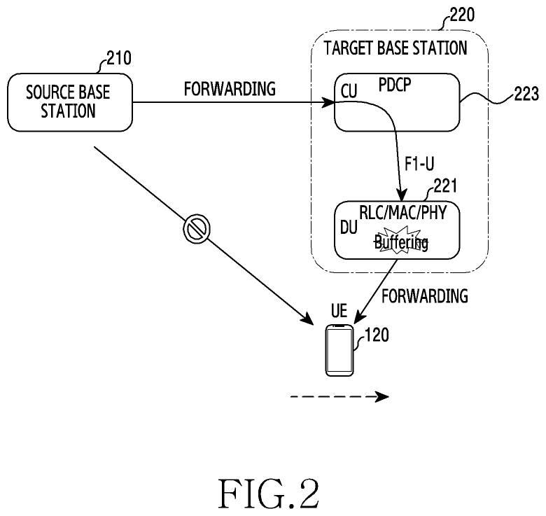

FIG. 2 is a diagram illustrating an example of a handover procedure according to various embodiments.

Referring to FIG. 2, in a mobile communication system (e.g., 100 of FIG. 1), the UE 120 may report (e.g., measurement report (MR)) measurement information and signal strength to a source base station 210 after receiving the handover command transmitted from the source base station 210. The source base station 210 may determine a target base station 220 according to an internal policy based on the measurement information and signal strength transmitted from the UE 120. If the source base station 210 determines to perform handover to the target base station 220, the source base station 210 may transmit a handover request message to the target base station 220.

According to an embodiment of the disclosure, the handover request message may include configuration information related to the handover of the UE 120. The configuration information related to the handover may include downlink forwarding information, information on the requested location reporting function, and information on roaming, areas, and access restrictions of the target base station.

According to an embodiment of the disclosure, in order to prevent and/or reduce data loss during the handover process, it may be necessary to transfer data that should be forwarded to the UE 120 from the PDCP layer of the source base station 210 to the PDCP layer of the target base station 220. According to an embodiment of the disclosure, the PDCP layer of the target base station 220 may correspond to the CU 223 of the target base station 220. According to an embodiment of the disclosure, data that should be forwarded to the UE 120 may refer, for example, to data transferred from the core network to the source base station until the UE 120 is connected to the target base station 220 after the UE 120 is disconnected from the source base station 210 due to the performing handover procedure.

According to an embodiment of the disclosure, data that should be forwarded to the UE 120 may be forwarded to the UE 120 from the CU 223 of the target base station 220 through the DU 221 of the target base station 220. Data that should be forwarded to the UE 120 received from the source base station 210 may be stored in the buffer of the CU 223 of the target base station 220. The buffer of the CU 223 of the target base station 220 may be located in the PDCP entity of the CU 223 of the target base station 220. After the handover is completed, the data stored in the buffer of the CU 223 of the target base station 220 should be forwarded to the UE 120 from the CU 223 of the target base station 220 through the DU 221 of the target base station 220, but because of the distance between the CU 223 of the target base station 220 and the DU 221 of the target base station 220, the time taken to be forwarded to the UE 120 may increase. Accordingly, the handover interruption time may increase.

According to an embodiment of the disclosure, in order to reduce the handover interruption time, the CU 223 of the target base station 220 may forward data that should be forwarded to the UE 120 received from the source base station 210 to the DU 221 of the target base station 220. For example, immediately after receiving data that should be forwarded to the UE 120 from the source base station 210 (or within a predetermined (e.g., specified) time), the CU 223 of the target base station 220 may forward data that should be forwarded to the UE 120 from the source base station 210 to the DU 221 of the target base station 220. Thereafter, data that should be forwarded to the UE 120 received from the source base station 210 may be stored in the buffer of the DU 221 of the target base station 220. According to an embodiment of the disclosure, the buffer of the DU 221 of the target base station 220 may be located in at least one of radio link control (RLC), MAC, PHY, and RF entities of the DU 221 of the target base station 220. After the handover is completed, since the data stored in the buffer of the DU 221 of the target base station 220 is forwarded from the DU 221 of the target base station 220 to the UE 120, the time taken to be forwarded to the UE 120 may be determined by the distance between the DU 221 of the target base station 220 and the UE 120 regardless of the distance between the CU 223 of the target base station 220 and the DU 221 of the target base station 220. Accordingly, the handover interruption time may be reduced.

According to an embodiment of the disclosure, regarding data that should be forwarded to the UE 120 from the CU 223 of the target base station 220, forwarding by the source base station 210 may be performed based on configuration information related to the handover received from the source base station 210. The source base station 210 may transmit a handover request message to the CU 223 of the target base station 220. The handover request message may include configuration information related to the handover of the UE 120.

According to an embodiment of the disclosure, the CU 223 of the target base station 220 may receive data that should be forwarded to the UE 120 from the source base station 210 based on the configuration information related to the handover received from the source base station 210. According to an embodiment of the disclosure, regarding the data that should be forwarded to the UE 120, forwarding of the source base station 210 may be performed between the PDCP layer of the source base station 210 and the PDCP layer of the CU 223 of the target base station 220. According to an embodiment of the disclosure, the data that should be forwarded to the UE 120 may be data that the UE 120 has not received from the source base station 210 due to the performing handover procedure.

According to an embodiment of the disclosure, the CU 223 of the target base station 220 may forward data that should be forwarded to the UE 120 received from the source base station 210 to the DU 221 of the target base station 220. For example, immediately after receiving data that should be forwarded to the UE 120 from the source base station 210, the CU 223 of the target base station 220 may forward data that should be forwarded to the UE 120 from the source base station 210 to the DU 221 of the target base station 220. Thereafter, data that should be forwarded to the UE 120 received from the source base station 210 may be stored in the buffer of the DU 221 of the target base station 220. According to an embodiment of the disclosure, the buffer of the DU 221 of the target base station 220 may be located in at least one of RLC, MAC, PHY, and RF entities of the DU 221 of the target base station 220.

According to an embodiment of the disclosure, the UE 120 and the DU 221 of the target base station 220 may perform a handover procedure. The handover procedure may include a random access procedure between the UE 120 and the DU 221 of the target base station 220 and a procedure in which the UE 120 transmits a handover complete message to the target base station 220. The handover complete message may include a message regarding the completion of the RRC connection reconfiguration (e.g., RRCConnectionReconfigurationComplete).

According to an embodiment of the disclosure, the random access procedure may include a procedure in which the UE 120 transmits a random access preamble to the DU 221 of the target base station 220 through a physical random access channel (PRACH), and a procedure in which the DU 221 of the target base station 220 transmits a random access response message to the UE 120 in response to the random access preamble.

According to an embodiment of the disclosure, if a dedicated random access preamble is allocated in a handover command message transmitted by the source base station 210, in a procedure in which the UE 120 transmits the random access preamble to the DU 221 of the target base station 220 through a physical random access channel (PRACH), the UE 120 may perform a contention free random access procedure.

According to an embodiment of the disclosure, a random access procedure 530 may include a procedure in which the UE 120 transmits a random access response message to the DU 221 of the target base station 220 in response to the random access preamble. The random access response message may include uplink radio resource allocation information and timing advance (TA) information. Here, the random access response message may be transmitted through a downlink-shared channel (DL-SCH). The random access response message may further include a temporary cell-radio network temporary identifier (C-RNTI).

According to an embodiment of the disclosure, the UE 120 may transmit the handover complete message to the DU 221 of the target base station 220. According to an embodiment of the disclosure, if the random access of the UE to the DU 221 of the target base station 220 is successful, the UE 120 may transmit a handover complete message including an uplink buffer status report message to the target base station. According to an embodiment of the disclosure, the handover complete message may be transmitted in the form of a message regarding the completion of the RRC connection reconfiguration (e.g., RRCConnectionReconfigurationComplete). According to an embodiment of the disclosure, the handover complete message may be referred to as a handover confirm message.

According to an embodiment of the disclosure, after the handover procedure, the DU 221 of the target base station 220 may forward data stored in the buffer of the DU 221 of the target base station 220 to the UE 120. For example, the DU 221 of the target base station 220 may forward the data stored in the buffer of the DU 221 of the target base station 220 to the UE 120 after receiving the handover complete message.

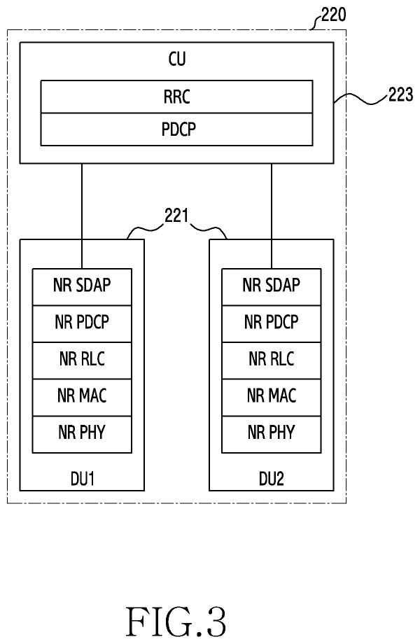

FIG. 3 is a diagram illustrating an example protocol stack of a target base station in a mobile communication system according to various embodiments. The protocol stack of the target base station 220 illustrated in FIG. 3 may be understood as a configuration of the base station 110 and the source base station 210 as well as the target base station 220. FIG. 3 illustrates of a control plane protocol structure for control and a user plane protocol structure for the user.

Referring to FIG. 3, the DU 221 of the target base station 220 processes layers such as radio frequency (RF), physical (PHY), media access control (MAC), and radio link control (RLC), and the CU 223 of the target base station 220 processes layers such as packet data conversion protocol (PDCP) and radio resource control (RRC). An interface between the DU 221 of the target base station 220 and the CU 223 of the target base station 220 may be referred to as “F1”.

Example functions of RRC may include some of the following functions. The RRC is not limited to the following examples and may perform various functions.
Broadcast of system information related to access stratum (AS) and non-access stratum (NAS)
Paging initiated by 5GC or NG-RAN
Establishment, maintenance and release of RRC connection between UE and NG-RAN (additionally, including modification and release of carrier aggregation, and, in addition, including modification and release of dual connectivity between E-UTRAN and NR or within NR)
Security functions including key management
Establishment, configuration, maintenance and release of SRB(s) and DRB(s); Handover and context transfer
Control of UE cell selection, re-release and cell selection/reselection
Mobility functions including inter-RAT mobility
QoS management function
UE measurement reporting and report control
Detection of and recovery from radio link failure
NAS message transfer from NAS to UE and NAS message transfer from UE to NAS

The main functions of NR SDAP may include some of the following functions. The NR SDAP is not limited to the following examples and may perform various functions.
Transfer of user plane data
Mapping between a QoS flow and a DRB for both downlink (DL) and uplink (UL)
Marking QoS flow ID in both DL and UL packets
Reflective QoS flow to DRB mapping for the UL SDAP PDUs

For the NR SDAP layer device, the UE may be configured whether to use the header of the NR SDAP layer device for each PDCP layer device, for each bearer, or for each logical channel, or whether to use the function of the NR SDAP layer device by a radio resource control (RRC) message received from the base station. When the SDAP header is configured, the terminal may be indicated to update or reconfigure mapping information for QoS flow and data bearer of the uplink and downlink using an 1-bit indicator (NAS reflective QoS) for reflecting non-access stratum (NAS) quality of service (QOS) and an 1-bit indicator (AS reflective QoS) for reflecting access stratum (AS) quality of service (QOS) of the SDAP header. The SDAP header may include QoS flow ID information indicating QoS. QoS information may be used as data processing priority, scheduling information, etc. to support desired services.

Example functions of NR PDCP may include some of the following functions. The NR PDCP is not limited to the following examples and may perform various functions.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering function of the NR PDCP device may refer to a function of reordering PDCP PDUs received from a lower layer in order based on the PDCP sequence number (SN). The reordering function of the NR PDCP device may include functions such as delivering data to the upper layer in the reordered order, delivering data directly without considering the order, recording lost PDCP PDUs by reordering the order, reporting status of lost PDCP PDUs to the transmitter, and requesting retransmission of lost PDCP PDUs.

Example functions of NR RLC may include some of the following functions. The NR RLC is not limited to the following examples and may perform various functions.
Transfer of upper layer PDUs
In-sequence delivery of upper layer PDUs
Out-of-sequence delivery of upper layer PDUs
Error correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery function of the NR RLC device may refer to a function of delivering RLC SDUs received from a lower layer to an upper layer in order. When, originally, one RLC SDU is divided into multiple RLC SDUs and received, the in-sequence delivery function of the NR RLC device may include a function of reassembling and delivering the RLC SDU.

The in-sequence delivery function of the NR RLC device may include functions such as reordering received RLC PDUs based on the RLC sequence number (SN) or PDCP sequence number (SN), recording lost RLC PDUs by reordering the order, reporting status of lost RLC PDUs to the transmitter, and requesting retransmission of lost RLC PDUs.

The in-sequence delivery function of the NR RLC device may include a function to deliver only the RLC SDUs up to the lost RLC SDU to the upper layer in order when there is a lost RLC SDU.

The in-sequence delivery function of the NR RLC device may include a function to deliver all received RLC SDUs to the upper layer in order before the timer starts if a predetermined timer has expired even if there is a lost RLC SDU.

The in-sequence delivery function of the NR RLC device may include a function to deliver all RLC SDUs received so far to the upper layer in order if a predetermined timer has expired even if there is a lost RLC SDU.

The NR RLC device may process RLC PDUs in the order of receiving them (out-of-sequence delivery) and deliver them to the PDCP device.

When receiving a segment, the NR RLC device may receive segments that are stored in the buffer or will be received later, reassemble them into a complete RLC PDU, and then deliver them to the PDCP device.

The NR RLC layer may not include a concatenation function, and the concatenation function may be performed in the MAC layer or replaced with the multiplexing function of the MAC layer.

The out-of-sequence delivery function of the NR RLC device may refer to a function of delivering RLC SDUs received from a lower layer to an upper layer regardless of the order. When, originally, one RLC SDU is divided into multiple RLC SDUs and received, the out-of-sequence delivery function of the NR RLC device may include a function of reassembling and delivering the RLC SDU. The out-of-sequence delivery function of the NR RLC device may include a function to store the RLC SN or PDCP sequence number (SN) of the received RLC PDUs and sort the order to record the lost RLC PDUs.

NR MAC may be connected to multiple RLC layer devices configured in one UE, and example functions of the NR MAC may include some of the following functions. The NR MAC is not limited to the following examples and may perform various functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

NR physical (PHY) layer may perform the operation of channel coding and modulating upper layer data, making the data into an OFDM symbol to transmit the same to a radio channel, or demodulating and channel decoding the OFDM symbol received through the radio channel and delivering the same to the upper layer. The PHY is not limited to these examples and may perform various functions.

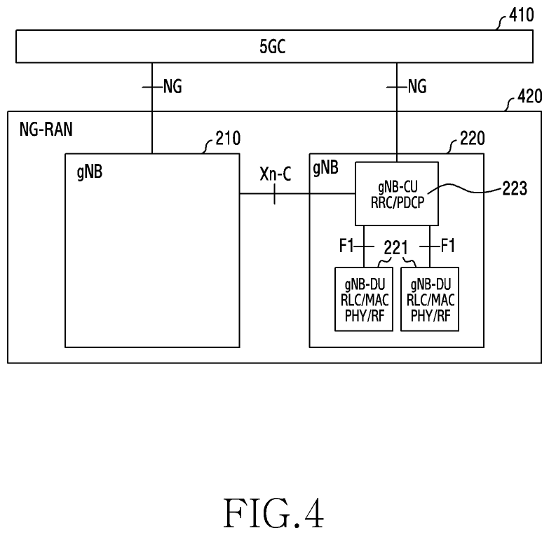

FIG. 4 is a diagram illustrating an example core network and a base station in a mobile communication system according to various embodiments. 5G core (5GC) 410 may include various network functions (NFs) by considering network function virtualization (NFV) technology and software defined networking (SDN) technology. Next generation radio access network (NG-RAN) 420 is designed to accommodate both 5G new radio (NR) and existing LTE radio access, and may include a 5G NR base station (gNodeB) and an LTE E-UTRA (evolved universal mobile telecommunications system (UMTS) terrestrial radio access) base station (eNodeB).

The base station 110 according to various embodiments of the disclosure may be implemented to form an access network having a distributed deployment as well as an integrated deployment. According to an embodiment, the base station 110 may be divided into a central unit (CU) and a distributed unit (DU), and the CU may be implemented to perform upper layers (e.g., packet data convergence protocol (PDCP), RRC) and the DU may be implemented to perform lower layers (e.g., medium access control (MAC), physical (PHY)). The DU of the base station 110 may form beam coverage on a radio channel.

Referring to FIG. 4, the interface between the 5GC 410 and the NG-RAN 420 may be referred to as “NG”. The interface between the source base station 210 and the target base station 220 may be referred to as “Xn”. The interface between the DU 221 of the target base station 220 and the CU 223 of the target base station 220 may be referred to as “F1”. Although FIG. 4 illustrates that the NG-RAN 420 includes the source base station 210 and the target base station 220, the disclosure is not limited thereto. For example, another base station may be included. For example, the other base station may be the base station 110.

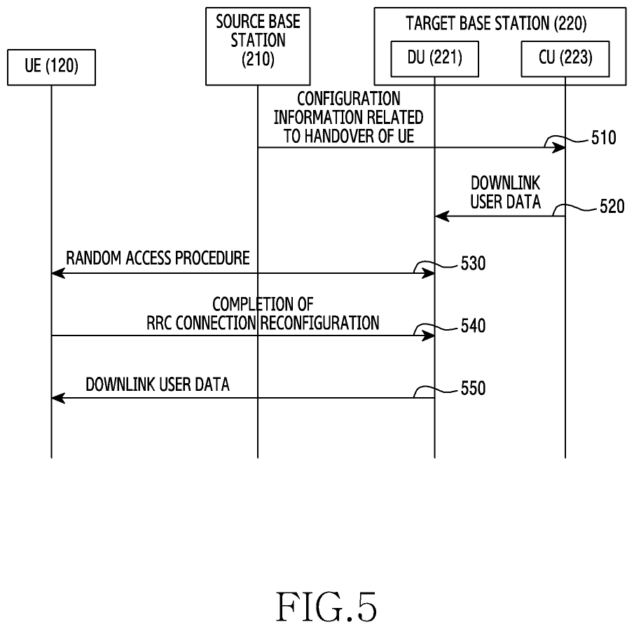

FIG. 5 is a signal flow diagram illustrating an example of a handover procedure in a mobile communication system according to various embodiments.

In operation 510, the source base station 210 may transmit a handover request message to the CU 223 of the target base station 220. The handover request message may include configuration information related to the handover of the UE 120. The configuration information related to the handover may include downlink forwarding information, information on the requested location reporting function, and information on roaming, areas, and access restrictions of the target base station.

According to an embodiment of the disclosure, the CU 223 of the target base station 220 may receive data that should be forwarded to the UE 120 from the source base station 210 based on the configuration information related to the handover received from the source base station 210 (not shown). According to an embodiment of the disclosure, regarding the data that should be forwarded to the UE 120, forwarding of the source base station 210 may be performed between the PDCP layer of the source base station 210 and the PDCP layer of the CU 223 of the target base station 220. According to an embodiment of the disclosure, the data that should be forwarded to the UE 120 may be data that the UE 120 has not received from the source base station 210 due to the performing handover procedure.

In operation 520, the CU 223 of the target base station 220 may forward data that should be forwarded to the UE 120 received from the source base station 210 to the DU 221 of the target base station 220. For example, immediately after receiving data that should be forwarded to the UE 120 from the source base station 210, the CU 223 of the target base station 220 may forward data that should be forwarded to the UE 120 from the source base station 210 to the DU 221 of the target base station 220. Data that should be forwarded to the UE 120 may be downlink user data. Thereafter, data that should be forwarded to the UE 120 received from the source base station 210 may be stored in the buffer of the DU 221 of the target base station 220. According to an embodiment of the disclosure, the data that should be forwarded to the UE 120 may be data that the UE 120 has not received from the source base station 210 due to the performing handover procedure.

According to an embodiment of the disclosure, the data that should be forwarded to the UE 120 received from the source base station 210 may be stored in the buffer of the DU 221 of the target base station 220, and the buffer of the DU 221 of the target base station 220 may be located in at least one of RLC, MAC, PHY, and RF entities of the DU 221 of the target base station 220. After the handover is completed, since the data stored in the buffer of the DU 221 of the target base station 220 is forwarded from the DU 221 of the target base station 220 to the UE 120, the time taken to be forwarded to the UE 120 may be determined by the distance between the DU 221 of the target base station 220 and the UE 120 regardless of the distance between the CU 223 of the target base station 220 and the DU 221 of the target base station 220. Accordingly, the handover interruption time may be reduced.

In operation 530, the UE 120 and the DU 221 of the target base station 220 may perform a random access procedure. According to an embodiment of the disclosure, the source base station 210 may transmit a handover command message to the UE 120 before step 530 of performing the random access procedure. According to an embodiment of the disclosure, the source base station 210 may transmit the handover command message to the UE 120 after the step 510 of transmitting the handover request message. According to an embodiment of the disclosure, the handover command message may be transmitted in the form of a message (e.g., RRCConnectionReconfiguration) related to RRC connection reconfiguration.

According to an embodiment of the disclosure, the operation 530 performing the random access procedure may include a procedure in which the UE 120 transmits a random access preamble to the DU 221 of the target base station 220 through a physical random access channel (PRACH), and a procedure in which the DU 221 of the target base station 220 transmits a random access response message to the UE 120 in response to the random access preamble.

According to an embodiment of the disclosure, the random access procedure 530 may include a procedure in which the DU 221 of the target base station 220 transmits the random access response message to the UE 120 in response to the transmitting the random access preamble from the UE 120 to the DU 221 of the target base station 220.

In operation 540, the UE 120 may transmit the handover complete message to the DU 221 of the target base station 220. According to an embodiment of the disclosure, if the random access of the UE to the DU 221 of the target base station 220 is successful, the UE 120 may transmit a handover complete message including an uplink buffer status report message to the target base station. According to an embodiment of the disclosure, the handover complete message may be transmitted in the form of a message regarding the completion of the RRC connection reconfiguration (e.g., RRCConnectionReconfigurationComplete). According to an embodiment of the disclosure, the handover complete message may be referred to as a handover confirm message.

In operation 550, the DU 221 of the target base station 220 may forward data stored in the buffer of the DU 221 of the target base station 220 to the UE 120. For example, the DU 221 of the target base station 220 may forward the data stored in the buffer of the DU 221 of the target base station 220 to the UE 120 after receiving the handover complete message.

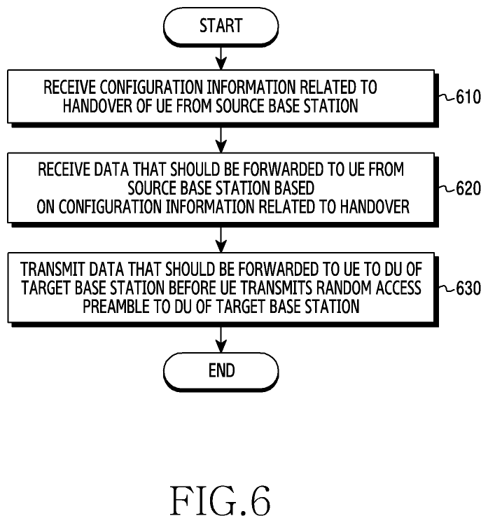

FIG. 6 is a flowchart illustrating an example of a handover procedure of a CU of a target base station in a mobile communication system according to various embodiments.

In operation 610, the CU 223 of the target base station 220 may receive the configuration information related to the handover of the UE 120 from the source base station 210. The source base station 210 may transmit a handover request message to the CU 223 of the target base station 220, and the handover request message may include configuration information related to the handover of the UE 120. The configuration information related to the handover may include downlink forwarding information, information on the requested location reporting function, and information on roaming, areas, and access restrictions of the target base station.

In operation 620, the CU 223 of the target base station 220 may receive data that should be forwarded to the UE 120 from the source base station 210 based on the configuration information related to the handover. According to an embodiment of the disclosure, regarding the data that should be forwarded to the UE 120, forwarding of the source base station 210 may be performed between the PDCP layer of the source base station 210 and the PDCP layer of the CU 223 of the target base station 220. According to an embodiment of the disclosure, the data that should be forwarded to the UE 120 may be data that the UE 120 has not received from the source base station 210 due to the performing handover procedure.

In operation 630, before the DU 221 of the target base station 220 receives a random access preamble transmitted from the UE 120, the CU 223 of the target base station 220 may transmit data that should be forwarded to the UE 120 to the DU 221 of the target base station 220. For example, immediately after receiving data that should be forwarded to the UE 120 from the source base station 210 (or within a predetermined time), the CU 223 of the target base station 220 may forward data that should be forwarded to the UE 120 from the source base station 210 to the DU 221 of the target base station 220. Data that should be forwarded to the UE 120 may be downlink user data. Thereafter, data that should be forwarded to the UE 120 received from the source base station 210 may be stored in the buffer of the DU 221 of the target base station 220. According to an embodiment of the disclosure, the data that should be forwarded to the UE 120 may be data that the UE 120 has not received from the source base station 210 due to the performing handover procedure.

According to an embodiment of the disclosure, the data that should be forwarded to the UE 120 received from the source base station 210 may be stored in the buffer of the DU 221 of the target base station 220, and the buffer of the DU 221 of the target base station 220 may be located in at least one of RLC, MAC, PHY, and RF entities of the DU 221 of the target base station 220. After the handover is completed, since the data stored in the buffer of the DU 221 of the target base station 220 is forwarded from the DU 221 of the target base station 220 to the UE 120, the time taken to be forwarded to the UE 120 may be determined by the distance between the DU 221 of the target base station 220 and the UE 120 regardless of the distance between the CU 223 of the target base station 220 and the DU 221 of the target base station 220. Accordingly, the handover interruption time may be reduced.

According to an embodiment of the disclosure, the UE 120 and the DU 221 of the target base station 220 may perform a random access procedure. According to an embodiment of the disclosure, the source base station 210 may transmit a handover command message to the UE 120 before operation 530 of performing the random access procedure. According to an embodiment of the disclosure, the source base station 210 may transmit the handover command message to the UE 120 after operation 510 of transmitting the handover request message. According to an embodiment of the disclosure, the handover command message may be transmitted in the form of a message (e.g., RRCConnectionReconfiguration) related to RRC connection reconfiguration.

According to an embodiment of the disclosure, operation 530 performing the random access procedure may include a procedure in which the UE 120 transmits a random access preamble to the DU 221 of the target base station 220 through a physical random access channel (PRACH), and a procedure in which the DU 221 of the target base station 220 transmits a random access response message to the UE 120 in response to the random access preamble.

In addition, according to an embodiment of the disclosure, the random access procedure 530 may include a procedure in which the DU 221 of the target base station 220 transmits the random access response message to the UE 120 in response to the UE 120 transmitting the random access preamble to the DU 221 of the target base station 220.

According to an embodiment of the disclosure, the UE 120 may transmit the handover complete message to the DU 221 of the target base station 220. According to an embodiment of the disclosure, if the random access of the UE to the DU 221 of the target base station 220 is successful, the UE 120 may transmit a handover complete message including an uplink buffer status report message to the target base station. According to an embodiment of the disclosure, the handover complete message may be transmitted in the form of a message regarding the completion of the RRC connection reconfiguration (e.g., RRCConnectionReconfigurationComplete). According to an embodiment of the disclosure, the handover complete message may be referred to as a handover confirm message.

According to an embodiment of the disclosure, the DU 221 of the target base station 220 may forward data stored in the buffer of the DU 221 of the target base station 220 to the UE 120 received from source base station 210. For example, the DU 221 of the target base station 220 may forward the data stored in the buffer of the DU 221 of the target base station 220 to the UE 120 after receiving the handover complete message. According to an embodiment of the disclosure, data stored in the buffer of the DU 221 of the base station 220 may be transmitted from the DU 221 of the target base station 220 to the UE 120 based on the transmission of the handover complete message to the DU 221 of the target base station 220.

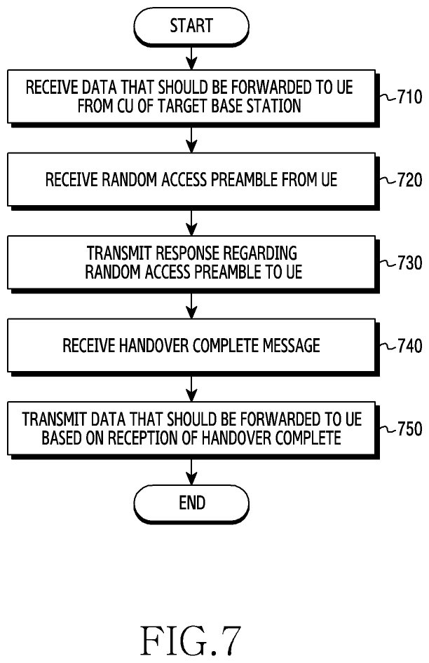

FIG. 7 is a flowchart illustrating an example of a handover procedure of a DU of a target base station in a mobile communication system according to various embodiments.

In operation 710, the DU 221 of the target base station 220 may receive data that should be forwarded to the UE 120 from the CU 223 of the target base station 220. For example, immediately after receiving data that should be forwarded to the UE 120 from the source base station 210 (or within a predetermined time), the CU 223 of the target base station 220 may forward data that should be forwarded to the UE 120 from the source base station 210 to the DU 221 of the target base station 220. According to an embodiment of the disclosure, the data that should be forwarded to the UE 120 may be received by the CU 223 of the target base station 220 based on the handover-related configuration information received from the source base station 210.

Data that should be forwarded to the UE 120 may be downlink user data. According to an embodiment of the disclosure, the data that should be forwarded to the UE 120 may be data that the UE 120 has not received from the source base station 210 due to the performing handover procedure.

According to an embodiment of the disclosure, the data that should be forwarded to the UE 120 received from the source base station 210 may be stored in the buffer of the DU 221 of the target base station 220, and the buffer of the DU 221 of the target base station 220 may be located in at least one of RLC, MAC, PHY, and RF entities of the DU 221 of the target base station 220. After the handover is completed, since the data stored in the buffer of the DU 221 of the target base station 220 is forwarded from the DU 221 of the target base station 220 to the UE 120, the time taken to be forwarded to the UE 120 may be determined by the distance between the DU 221 of the target base station 220 and the UE 120 regardless of the distance between the CU 223 of the target base station 220 and the DU 221 of the target base station 220. Accordingly, the handover interruption time may be reduced.

According to an embodiment of the disclosure, the source base station 210 may transmit a handover request message to the CU 223 of the target base station 220. According to an embodiment of the disclosure, the handover request message may include configuration information related to the handover of the UE 120. The configuration information related to the handover may include downlink forwarding information, information on the requested location reporting function, and information on roaming, areas, and access restrictions of the target base station.

In operation 720, the DU 221 of the target base station 220 may receive a random access preamble from the UE 120.

In operation 730, the DU 221 of the target base station 220 may transmit a response regarding the random access preamble to the UE 120. According to an embodiment of the disclosure, transmission of the response regarding the random access preamble may correspond to a procedure in which the DU 221 of the target base station 220 transmits the random access response message to the UE 120 in response to the random access preamble transmitted by the UE 120 to the DU 221 of the target base station 220.

In operation 740, the DU 221 of the target base station 220 may receive the handover complete message from the UE 120. According to an embodiment of the disclosure, if the random access of the UE to the DU 221 of the target base station 220 is successful, the UE 120 may transmit a handover complete message including an uplink buffer status report message to the target base station. According to an embodiment of the disclosure, the handover complete message may be transmitted in the form of a message regarding the completion of the RRC connection reconfiguration (e.g., RRCConnectionReconfigurationComplete). According to an embodiment of the disclosure, the handover complete message may be referred to as a handover confirm message.

In operation 750, the DU 221 of the target base station 220 may transmit data that should be forwarded to the UE 120 to the UE 120 after receiving the handover complete message. According to an embodiment of the disclosure, after receiving the handover complete message, data stored in the buffer of the DU 221 of the target base station 220, received from the CU 223 of the target base station 220 before the random access preamble, may be forwarded from the DU 221 of the target base station 220 to the UE 120. Since the data stored in the buffer of the DU 221 of the target base station 220 is forwarded from the DU 221 of the target base station 220 to the UE 120, the time taken to be forwarded to the UE 120 may be determined by the distance between the DU 221 of the target base station 220 and the UE 120 regardless of the distance between the CU 223 of the target base station 220 and the DU 221 of the target base station 220. Accordingly, the handover interruption time may be reduced.

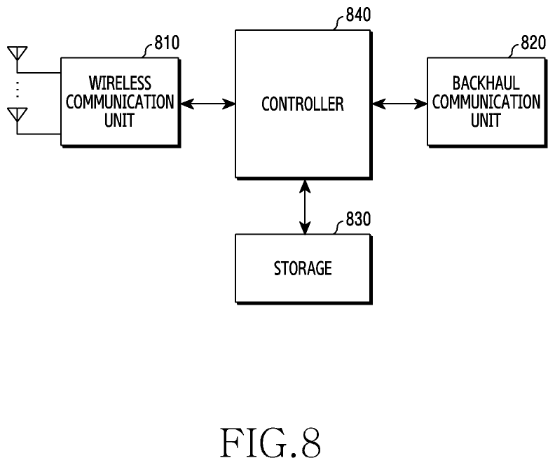

FIG. 8 is a block diagram illustrating an example configuration of a base station according to various embodiments. The structure of the base station illustrated in FIG. 8 may be understood as a structure of the base station 110, the source base station 210, or the target base station 220. The structure illustrated in FIG. 8 may be understood as a structure of the CU 223 of the target base station 220. As used herein, such terms as “ . . . unit” and “ . . . er” refer to a unit configured to process at least one function or operation, and may be implemented as hardware, software, or a combination of hardware and software.

Referring to FIG. 8, the base station includes a wireless communication unit (e.g., including wireless communication circuitry) 810, a backhaul communication unit (e.g., including backhaul communication circuitry) 820, a storage unit (e.g., including a memory) 830, and a controller (e.g., including circuitry) 840.

The wireless communication unit 810 may include various wireless communication circuitry and performs functions for transmitting/receiving signals through a radio channel. For example, the wireless communication unit 810 performs functions of conversion between baseband signals and bitstrings according to the physical layer specifications of the system. For example, during data transmission, the wireless communication unit 810 encodes and modulates a transmitted bitstring to generate complex symbols. In addition, during data reception, the wireless communication unit 810 demodulates and decodes a baseband signal to reconstruct a received bitstring. Furthermore, the wireless communication unit 810 up-converts a baseband signal to an RF band signal, transmits the same through an antenna, and down-converts an RF band signal received through the antenna to a baseband signal.

The wireless communication unit 810 may include a transmission filter, a reception filter, an amplifier, a mixer, an oscillator, a digital to analog converter (DAC), an analog to digital converter (ADC), and the like. In addition, the wireless communication unit 810 may include multiple transmission/reception paths. Furthermore, the wireless communication unit 810 may include at least one antenna array including multiple antenna elements. In terms of hardware, the wireless communication unit 810 may include a digital unit and an analog unit, and the analog unit may include multiple sub-units according to operation power, frequencies, etc.

The wireless communication unit 810 may transmit/receive signals. The wireless communication unit 810 may include at least one transceiver. For example, the communication unit 810 may transmit a synchronization signal, a reference signal, system information, a message, control information, data, or the like. In addition, the wireless communication unit 810 may perform beamforming.

The wireless communication unit 810 transmits and/or receives signals as described above. Accordingly, all or part of the communication unit 810 may be referred to as a “transmitter”, a “receiver”, or a “transceiver”. In addition, as used in the following description, the meaning of “transmission and reception performed through a radio channel” includes the meaning that the above-described processing is performed by the wireless communication unit 810.

The backhaul communication unit 820 may include various circuitry and/or executable program instructions and provides an interface for performing communication with other nodes in the network. For example, the backhaul communication unit 820 converts bitstrings transmitted from the base station to other nodes, for example, other access nodes, other base stations, upper nodes, core networks, or the like to physical signals, and convers physical signals received from other nodes to bitstrings.

The storage unit 830 may include a memory and may store basic programs, application programs, and data, such as configuration information, for operation of the main base station. The storage unit 830 may include a memory. The storage unit 830 may include a volatile memory, a nonvolatile memory, or a combination of a volatile memory and a nonvolatile memory. In addition, the storage unit 830 provides the stored data at the request of the controller 840. According to an embodiment, the storage unit 830 may store learning data for handover.

The controller 840 may include various circuitry and controls the overall operation of the base station. For example, the controller 840 transmits/receives signals through the wireless communication unit 810 or the backhaul communication unit 820. The controller 840 records data in the storage unit 830 and reads the data from the storage unit 830. The controller 840 may perform functions of protocol stacks required by communication specifications. To this end, the controller 840 may include at least one processor.

According to an embodiment, the controller 840 may include a handover configuration unit. The handover configuration unit may include various circuitry and/or executable program instructions and perform determination of whether it is actually profitable to perform handover, determination of whether to perform handover, a configuration of parameters for handover, and the like. According to various embodiments, the controller 840 may control the base station to perform operations according to various embodiments.

The structure of the base station illustrated in FIG. 8 is a merely an example of the base station, and examples of the base station for performing various embodiment of the disclosure are not limited to the structure illustrated in FIG. 8. According to various embodiments of the disclosure, some components may be added, deleted, or modified.

In FIG. 8, the base station has been described as a single entity, but the disclosure is not limited thereto. In addition to the integrated deployment, the base station according to various embodiments of the disclosure may be implemented to construct an access network having a distributed deployment. According to an embodiment, the base station may be divided into a central unit (CU) and a digital unit (DU), the CU may be implemented to perform upper layer functions (e.g., packet data convergence protocol (PDCP) and RRC), and the DU may be implemented to perform lower layer functions (e.g., medium access control (MAC) and physical (PHY)). The DU of the base station may form beam coverage on a radio channel.

The base station having a distributed deployment may further include components for fronthaul interface communication. According to an embodiment, the base station, as the DU, may perform functions for transmitting/receiving signals in a wired communication environment. The DU may include a wired interface for a device-to-device direct connection through a transmission medium (e.g., copper wire or optical fiber). For example, the DU may transfer electrical signals to another device through copper wire, or may perform conversion between electrical signals and optical signals. The DU may be connected to the CU in a distributed deployment. However, this description should not be construed to exclude a scenario in which the DU is connected to the CU via a wireless network. In addition, the DU may be additionally connected to a radio unit (RU). However, this description should not be construed to exclude a radio environment including only the CU and the DU.

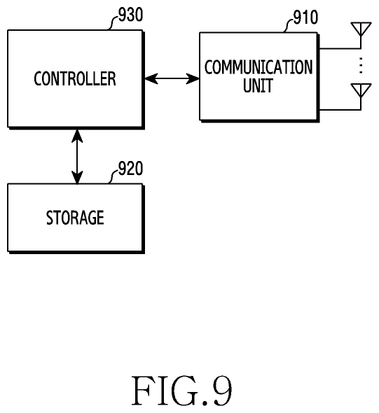

FIG. 9 is a block diagram illustrating an example configuration of a distributed unit (DU) of a target base station in a wireless communication system according to various embodiments. The structure of the DU of the target base station may be understood as a structure of the DU 221 of the target base station 220. As used herein, such terms as “ . . . unit” and “ . . . er” refer to a unit configured to process at least one function or operation, and may be implemented as hardware, software, or a combination of hardware and software.

Referring to FIG. 9, the DU of the target base station includes a wireless communication unit (e.g., including communication circuitry) 910, a storage unit (e.g., including a memory) 920, and a controller (e.g., including circuitry) 930.

The wireless communication unit 910 may include various communication circuitry and performs functions for transmitting/receiving signals through a radio channel. For example, the wireless communication unit 910 performs functions of conversion between baseband signals and bitstrings according to the physical layer specifications of the system. For example, during data transmission, the wireless communication unit 910 encodes and modulates a transmitted bitstring to generate complex symbols. In addition, during data reception, the wireless communication unit 910 demodulates and decodes a baseband signal to reconstruct a received bitstring. Furthermore, the wireless communication unit 910 up-converts a baseband signal to an RF band signal, transmits the same through an antenna, and down-converts an RF band signal received through the antenna to a baseband signal.

The wireless communication unit 910 may include a transmission filter, a reception filter, an amplifier, a mixer, an oscillator, a digital to analog converter (DAC), an analog to digital converter (ADC), and the like. In addition, the wireless communication unit 910 may include multiple transmission/reception paths. Furthermore, the wireless communication unit 910 may include at least one antenna array including multiple antenna elements. In terms of hardware, the wireless communication unit 910 may include a digital unit and an analog unit, and the analog unit may include multiple sub-units according to operation power, frequencies, etc.

The wireless communication unit 910 may transmit/receive signals. To this end, the wireless communication unit 210 may include at least one transceiver. For example, the wireless communication unit 910 may transmit a synchronization signal, a reference signal, system information, a message, control information, data, or the like. In addition, the wireless communication unit 910 may perform beamforming.

The wireless communication unit 910 transmits and/or receives signals as described above. Accordingly, all or part of the communication unit 910 may be referred to as a “transmitter”, a “receiver”, or a “transceiver”. In addition, as used in the following description, the meaning of “transmission and reception performed through a radio channel” includes the meaning that the above-described processing is performed by the wireless communication unit 910.

The storage unit 920 may include a memory and store basic programs, application programs, and data, such as configuration information, for operation of the main base station. The storage unit 920 may include a memory. The storage unit 920 may include a volatile memory, a nonvolatile memory, or a combination of a volatile memory and a nonvolatile memory. In addition, the storage unit 920 provides the stored data at the request of the controller 930. According to an embodiment, the storage unit 920 may store learning data for handover.

The controller 930 may include various circuitry and controls the overall operation of the DU 221 of the base station 220. For example, the controller 930 transmits/receives signals through the wireless communication unit 910 or the backhaul communication unit 920. The controller 930 records data in the storage unit 920 and reads the data from the storage unit 920. Furthermore, the controller 930 may perform functions of protocol stacks required by communication specifications. The controller 930 may include at least one processor.

According to an embodiment, the controller 930 may include a handover configuration unit including various circuitry and/or executable program instructions. The handover configuration unit may perform determination of whether it is actually profitable to perform handover, determination of whether to perform handover, a configuration of parameters for handover, and the like. According to various embodiments, the controller 930 may control the base station to perform operations according to various embodiments.

The structure of the DU 221 of the target base station 220 illustrated in FIG. 9 is a merely an example of the base station, and examples of the base station for performing various embodiment of the disclosure are not limited to the structure illustrated in FIG. 9. That is, according to various embodiments of the disclosure, some components may be added, deleted, or modified.

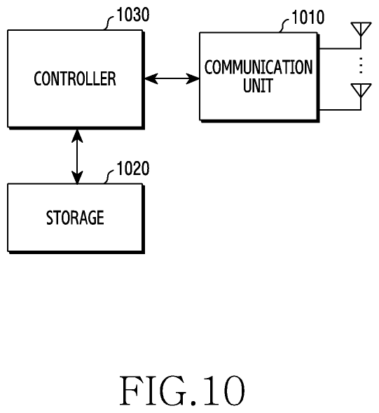

FIG. 10 is a block diagram illustrating an example configuration of a UE according to various embodiments. The structure illustrated in FIG. 10 may be understood as a structure of the UE 120. As used herein, such terms as “ . . . unit” and “ . . . er” refer to a unit configured to process at least one function or operation, and may be implemented as hardware, software, or a combination of hardware and software.

Referring to FIG. 10, the UE 120 includes a communication unit (e.g., including communication circuitry) 1010, a storage unit (e.g., including a memory) 1020, and a controller (e.g., including circuitry) 1030.

The communication unit 1010 may include various communication circuitry and performs functions for transmitting/receiving signals through a radio channel. For example, the communication unit 1010 performs functions of conversion between baseband signals and bitstrings according to the physical layer specifications of the system. For example, during data transmission, the communication unit 1010 generates complex symbols by encoding and modulating a transmission bitstream. In addition, during data reception, the communication unit 1010 demodulates and decodes a baseband signal to restore a received bitstring. In addition, the communication unit 1010 up-converts a baseband signal to an RF band signal, transmits the same through an antenna, and down-converts an RF band signal received through the antenna to a baseband signal. For example, the communication unit 1010 may include a transmission filter, a reception filter, an amplifier, a mixer, an oscillator, a DAC, and an ADC.

The communication unit 1010 may include multiple transmission/reception paths. The communication unit 1010 may include an antenna unit (e.g., including at least one antenna). The communication unit 1010 may include at least one antenna array configured by multiple antenna elements. In terms of hardware, the communication unit 1010 may include a digital circuit and an analog circuit (e.g., a radio frequency integrated circuit (RFIC)). The digital circuit and the analog circuit may be implemented as a single package. In addition, the communication unit 1010 may include multiple RF chains. The communication unit 1010 may perform beamforming. To assign directivity based on configurations of the controller 1030 to a signal to be transmitted/received, the communication unit 1010 may apply a beamforming weight to the signal. According to an embodiment, the communication unit 1010 may include a radio frequency (RF) block (or RF unit). The RF block may include first RF circuitry related to antennas and second RF circuitry related to baseband processing. The first RF circuitry may be referred to as an RF-antenna (RF-A). The second RF circuitry may be referred to as an RF-baseband (RF-B).

The communication unit 1010 may transmit/receive signals. To this end, the communication unit 1010 may include at least one transceiver. The communication unit 1010 may receive a downlink signal. The downlink signal may include a synchronization signal (SS), a reference signal (RS) (e.g., cell-specific reference signal (CRS)), a demodulation (DM)-RS, system information (e.g., MIB, SIB, remaining system information (RMSI), and other system information (OSI)), a configuration message, control information, downlink data, or the like. The communication unit 11001 may transmit an uplink signal. The uplink signal may include a random access-related signal (e.g., a random-access preamble (RAP) (or message 1 (Msg1) and message 3 (Msg3)), a reference signal (e.g., a sounding reference signal (SRS) and a DM-RS), a power headroom report (PHR), or the like.

The communication unit 1010 may include different communication modules for processing signals in different frequency bands. The communication unit 1010 may include multiple communication modules in order to support multiple different radio access techniques. For example, different radio access technologies may include Bluetooth low energy (BLE), wireless fidelity (Wi-Fi), Wi-Fi gigabyte (WiGig), cellular networks (e.g., long-term evolution (LTE)), new radio (NR), and the like. Also, the different frequency bands may include super high frequency (SHF) bands (e.g., 2.5 GHz or 5 GHz bands), millimeter wave (mmWave) bands (e.g., 38 GHZ or 60 GHz bands), and the like. The communication unit 1010 may also use the same type radio access technique in different frequency bands (e.g., unlicensed bands for licensed assisted access (LAA) or citizens broadband radio service (e.g., 3.5 GHZ)).

The communication unit 1010 transmits and/or receives signals as described above. Accordingly, all or part of the communication unit 1010 may be referred to as a “transmitter”, a “receiver”, or a “transceiver”. In addition, as used in the following description, the meaning of “transmission and reception performed through a radio channel” includes the meaning that the above-described processing is performed by the communication unit 1010.

The storage unit 1020 may include a memory and store basic programs, application programs, and data, such as configuration information, for operation of the main base station. The storage unit 1020 may include a volatile memory, a nonvolatile memory, or a combination of a volatile memory and a nonvolatile memory. In addition, the storage unit 1020 provides the stored data at the request of the controller 1030.

The controller 1030 may include various circuitry and controls overall operations of the UE 120. For example, the controller 1030 transmits/receives signals through the communication unit 1010. The controller 1030 records data in the storage unit 1020 and reads the data from the storage unit 1020. The controller 1030 may perform functions of protocol stacks required by communication specifications. The controller 1030 may include at least one processor. The controller 1030 may include at least one processor or micro-processor, or may be a part of a processor. In addition, a part of the communication unit 1010 and the controller 1030 may be referred to as a communication processor (CP). The controller 1030 may include various modules for performing communication. According to various embodiments, the controller 1030 may control the UE 120 to perform operations according to various embodiments. Thus, the controller 1030 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to various example embodiments of the disclosure, a method performed by a distributed unit (DU) of a target base station in a mobile communication system may include receiving data, to be forwarded to a UE, from a central unit (CU) of the target base station, wherein the data is data that the UE does not receive from a source base station due to a handover, receiving a random access preamble from the UE, transmitting a response to the random access preamble to the UE, receiving a handover complete message from the UE, and transmitting, to the UE, the data received from the CU of the target base station before receiving the random access preamble in response to the reception of the handover complete message.

According to an embodiment of the disclosure, storing the received data in a buffer of the DU of the target base station is further included, and transmitting the received data to the UE may include transmitting the data stored in the buffer.

According to an embodiment of the disclosure, the buffer may be located in at least one of a radio link control (RLC) entity, a medium access control (MAC) entity, a physical (PHY) entity, and a radio frequency (RF) entity of the DU of the target base station.

According to an embodiment of the disclosure, the data may be data transmitted from the source base station to the CU of the target base station, and may be transmitted to the UE based on configuration information related to the handover of the UE.

According to an embodiment of the disclosure, wherein the received data may be transmitted to the DU of the target base station within a predetermined time after the CU of the target base station receives the data.

According to various example embodiments of the disclosure, a method performed by a central unit (CU) of a target base station in a mobile communication system may include receiving, from a source base station, configuration information related to a handover of a UE, receiving data, to be forwarded to the UE, from the source base station based on the configuration information related to the handover, wherein the data is data that the UE does not receive from the source base station due to handover, and transmitting the received data to a distributed unit (DU) of the target base station before the DU of the target base station receives a random access preamble from the UE.

According to an embodiment of the disclosure, the received data may be transmitted to the DU of the target base station within a predetermined time after the CU of the target base station receives the data.

According to an embodiment of the disclosure, the received data may be stored in a buffer of the DU of the target base station.

According to an embodiment of the disclosure, the buffer may be located in at least one of a radio link control (RLC) entity, a medium access control (MAC) entity, a physical (PHY) entity, and a radio frequency (RF) entity of the DU of the target base station.

According to an embodiment of the disclosure, the data stored in the buffer may be transmitted from the DU of the target base station to the UE in response to the transmission of a handover complete message from the UE to the DU of the target base station.

According to various example embodiments of the disclosure, a distributed unit (DU) of a target base station in a mobile communication system may include a controller and a transceiver connected to the controller, and the controller may be configured to receive data, to be forwarded to a UE, from a central unit (CU) of the target base station, wherein the data is data that the UE does not receive from a source base station due to a handover, receive a random access preamble from the UE, transmit a response to the random access preamble to the UE, receive a handover complete message from the UE, and transmit, to the UE, the data received from the CU of the target base station before receiving the random access preamble in response to the reception of the handover complete message.

According to various example embodiments of the disclosure, a central unit (CU) of a target base station in a mobile communication system may include a controller and a transceiver connected to the controller, and the controller may be configured to receive, from a source base station, configuration information related to a handover of a UE, receive data, to be forwarded to the UE, from the source base station based on the configuration information related to the handover, wherein the data is data that the UE does not receive from the source base station due to handover, and transmit the received data to a distributed unit (DU) of the target base station before the DU of the target base station receives a random access preamble from the UE.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, a home appliance, or the like. The electronic device according to embodiments of the disclosure is not limited to those described above.

It should be appreciated that the various embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), the element may be coupled/connected with/to the other element directly (e.g., wiredly), wirelessly, or via a third element.

As used in various embodiments of the disclosure, the term “module” may include a unit implemented in hardware, software, or firmware, or any combination thereof, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., a program) including one or more instructions that are stored in a storage medium (e.g., an internal memory or external memory) that is readable by a machine (e.g., an electronic device). For example, a processor of the machine (e.g., an electronic device) may invoke at least one of the one or more instructions stored in the storage medium, and execute it. This allows the machine to be operated to perform at least one function according to the at least one instruction invoked. The one or more instructions each may include a code generated by a compiler or a code executable by an interpreter. The machine-readable storage medium may be provided in the form of a non-transitory storage medium. Herein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method performed by a distributed unit (DU) of a target base station in a mobile communication system, the method comprising:
receiving, from a central unit (CU) of the target base station, data to be forwarded to a user equipment, wherein the data includes data that the user equipment does not receive from a source base station due to a handover;
receiving a random access preamble from the user equipment;
transmitting a response to the random access preamble to the user equipment;
receiving a handover complete message from the user equipment; and
in response to receiving of the handover complete message, transmitting, to the user equipment, the data received from the CU of the target base station before receiving the random access preamble.

2. The method of claim 1, further comprising storing the received data in a buffer of the DU of the target base station,
wherein the transmitting of the received data to the user equipment comprises transmitting the data stored in the buffer.

3. The method of claim 2, wherein the buffer is located in at least one of a radio link control (RLC) entity, a medium access control (MAC) entity, a physical (PHY) entity, and a radio frequency (RF) entity of the DU of the target base station.

4. The method of claim 1, wherein the data is data transmitted from the source base station to the CU of the target base station, and is transmitted to the user equipment, based on configuration information related to the handover of the user equipment.

5. The method of claim 1 wherein the received data is transmitted to the DU of the target base station within a specified time after the CU of the target base station receives the data.

6. A method performed by a central unit (CU) of a target base station in a mobile communication system, the method comprising:
receiving, from a source base station, configuration information related to a handover of a user equipment;
based on the configuration information related to the handover, receiving, from the source base station, data to be forwarded to the user equipment, wherein the data includes data that the user equipment does not receive from the source base station due to handover; and
transmitting the received data to a distributed unit (DU) of the target base station before the DU of the target base station receives a random access preamble from the user equipment.

7. The method of claim 6, wherein the received data is transmitted to the DU of the target base station within a specified time after the CU of the target base station receives the data.

8. The method of claim 6, wherein the received data is stored in a buffer of the DU of the target base station.

9. The method of claim 8, wherein the buffer is located in at least one of a radio link control (RLC) entity, a medium access control (MAC) entity, a physical (PHY) entity, and a radio frequency (RF) entity of the DU of the target base station.

10. The method of claim 8, wherein the data stored in the buffer is transmitted from the DU of the target base station to the user equipment, in response to the transmission of a handover complete message from the user equipment to the DU of the target base station.

11. A distributed unit (DU) of a target base station in a mobile communication system, the DU comprising:
a transceiver;
a processor; and
memory storing instructions that, when executed by the processor, cause the DU to:
receive, from a central unit (CU) of the target base station, data to be forwarded to a user equipment, wherein the data includes data that the user equipment does not receive from a source base station due to a handover;
receive a random access preamble from the user equipment;
transmit a response to the random access preamble to the user equipment;
receive a handover complete message from the user equipment; and
in response to receiving the handover complete message, transmit, to the user equipment, the data received from the CU of the target base station before receiving the random access preamble.

12. The DU of claim 11, wherein the memory further comprises the instructions that, when executed by the processor, cause the DU to:
store the received data in a buffer of the DU of the target base station; and
transmit the data stored in the buffer to the user equipment.

13. The DU of claim 12, wherein the buffer is located in at least one of a radio link control (RLC) entity, a medium access control (MAC) entity, a physical (PHY) entity, and a radio frequency (RF) entity of the DU of the target base station.

14. The DU of claim 11, wherein the data includes data transmitted from the source base station to the CU of the target base station, and is transmitted to the user equipment, based on configuration information related to the handover of the user equipment.

15. The DU of claim 11, wherein the received data is transmitted to the DU of the target base station within a specified time after the CU of the target base station receives the data.

16. A central unit (CU) of a target base station in a mobile communication system, the CU comprising:
a transceiver;
a processor; and
memory storing instructions that, when executed by the processor, cause the CU to:
receive, from a source base station, configuration information related to a handover of a user equipment;
based on the configuration information related to the handover, receive, from the source base station, data to be forwarded to the user equipment, wherein the data includes data that the user equipment does not receive from the source base station due to handover; and
transmit the received data to a distributed unit (DU) of the target base station before the DU of the target base station receives a random access preamble from the user equipment.

17. The CU of claim 16, wherein the received data is transmitted to the DU of the target base station within a specified time after the CU of the target base station receives the data.

18. The CU of claim 16, wherein the received data is stored in a buffer of the DU of the target base station,

19. The CU of claim 18, wherein the buffer is located in at least one of a radio link control (RLC) entity, a medium access control (MAC) entity, a physical (PHY) entity, and a radio frequency (RF) entity of the DU of the target base station.

20. The CU of claim 18, wherein the data stored in the buffer is transmitted from the DU of the target base station to the user equipment, in response to the transmission of a handover complete message from the user equipment to the DU of the target base station.
